(19) United States
(12) Patent Application Publication
(10) Pub. No.: US 2006/0130480 A1
(43) Pub. Date: Jun. 22, 2006

(54) Method and system for geothermal electrical generation

(76) Inventor: Glenn Lovelace, Dripping Springs, TX (US)

Correspondence Address: Stacy S. Cook, Esq., 1507 Rio Bravo Loop, Leander, TX, 78641, US

(21) Appl. No.: 11/311,750

(22) Filed: Dec. 19, 2005

Related U.S. Application Data
(60) Provisional application No. 60/637,229, filed on Dec. 17, 2004.

(51) Int. Cl. F01K 27/00; F03G 7/00

(52) U.S. Cl. 60/641.2; 60/641.1

(57) ABSTRACT

A method and system for geothermal electrical generation is provided. The geothermal electrical generation system includes a thermal chamber, thermal conduit and a power head. The thermal chamber is disposed within a geothermal region of the earth and operates to heat a fluid that is communicated to the power head and used to generate electricity. The thermal chamber has a volume sufficiently large that the fluid has a high residence time and is heated to near equilibrium with the geothermal region.

### RELATED APPLICATIONS

This application claims benefit of previously filed U.S. Provisional Patent Application No. 60/637,229 having a filing date of Dec. 17, 2004.

### TECHNICAL FIELD OF THE INVENTION

The present invention relates generally to the field of geothermal energy, and in particular to a method and system for geothermal electrical generation.

### BACKGROUND OF THE INVENTION

The interior of the Earth contains a vast quantity of geothermal energy. In general, the temperature of the Earth increases by 30 degrees Centigrade for every 1,000 meters in depth. In certain geological regions, the temperature gradient is substantially higher. Most geothermal electricity generation applications are limited to these high temperature regions.

In one application, as illustrated by U.S. Pat. No. 6,708,494, two holes are drilled into a high temperature region, with one borehole being offset from the other borehole. Water or some other fluid is generally injected into one hole and works it way through cracks in the hot rock to the other hole, where the hot water is communicated to the surface. One of the problems with this application is that the water becomes contaminated as it flows through the hot rock. One solution to this problem is to encase the hole so that the water does not contact the hot rock and become contaminated, as illustrated by U.S. Pat. No. 6,301,894. Although this solves one problem, it also reduces the area over which heat can be applied to the water.

The water or steam heated in the interior of the Earth is generally communicated to the surface where it is often used to power a generator and generate electricity. In certain applications, the water is converted into steam and used to directly power a turbine generator, as illustrated by U.S. Pat. No. 6,212,890.

### BRIEF DESCRTIPTION OF THE INVENTION

In accordance with one embodiment of the present invention, a geothermal electrical generation system is provided. In this embodiment, the geothermal electrical generation system comprises a thermal chamber located in an underground geothermal region of the earth, a power head and a thermal conduit. A fluid is communicated through the thermal conduit to the thermal chamber where it is heated by the geothermal region. The heated fluid is then communicated from the thermal chamber to the power head where the heated fluid is used to generate electricity.

The thermal chamber comprises a number of unique embodiments that may be used individually or in combination with other embodiments of the present invention. For example, the walls forming the thermal chamber may be impermeable or semi-permeable. The volume of the thermal chamber may be greater than 3,000 cubic meters or greater than 5,000 cubic meters. The thermal chamber may also comprise various shapes, such as a generally domed shape, a generally spherical shape, or it may have multiple chambers. The thermal chamber may also be constructed using any number of construction techniques, including drilling, drift drilling, explosives, solution mining, spallation, laser drilling, under reaming, mining, remote mining, directional drilling, pressurized liquid and drilling wings. The thermal chamber may also allow the fluid to circulate freely or include features to create circulation.

The power head also comprises a number of unique embodiments that may be used individually or in combination with other embodiments of the present invention. For example, the power head may include a vaporization system, a generator system and a liquefaction system. In this embodiment, the heated fluid is vaporized in the vaporization system to create steam that powers the generator system to create electricity. The steam from the generator system is then liquefied into the fluid that is pumped into the thermal chamber to be heated. In another embodiment, the power head includes a heat exchanger that has a working fluid heated by the heated fluid from the thermal chamber. The working fluid is then used within the power head to generate electricity.

In accordance with another embodiment of the present invention, a method for generating electricity is provided. In one embodiment, the method comprises circulating a fluid through a thermal chamber and a power head wherein the fluid is heated within the thermal chamber and the heated fluid is used by the power head to generate electricity. In a particular embodiment, the fluid heated within the thermal chamber is used to heat a working fluid in a heat exchanger of the power head. The heated working fluid is then used to generate electricity.

In accordance with yet another embodiment of the present invention, a geothermal electrical generation system is provided. In this embodiment, the geothermal electrical generation system comprises a thermal chamber disposed in a thermal region of the earth having generally impermeable walls and a volume exceeding 5,000 cubic meters; a power head comprising a vaporization system, a generator system, a liquefaction system and a pumping system; and a thermal conduit for communicating a fluid between the power head and the thermal chamber.

### BRIEF DESCRIPTION OF THE DRAWINGS

The drawings illustrate certain embodiments of the invention. The drawing, description and claims include numerous characteristics individually and in combination. One skilled in the art will expediently assess the characteristics individually as well and put them together to make useful further combinations. Embodiments of the present invention are described below and shown by way of example in the accompanying drawings, wherein:

FIG. 1 is a cross sectional side view of a geothermal electrical generation system according to one embodiment of the present invention;

FIGS. 2A-2E are cross sectional representations of different embodiments of a thermal chamber in accordance with the present invention; and

FIGS. 3A-3B are block diagrams illustrating different embodiments of a power head in accordance with the present invention.

### DESCRIPTION OF THE PREFERRED EMBODIMENTS

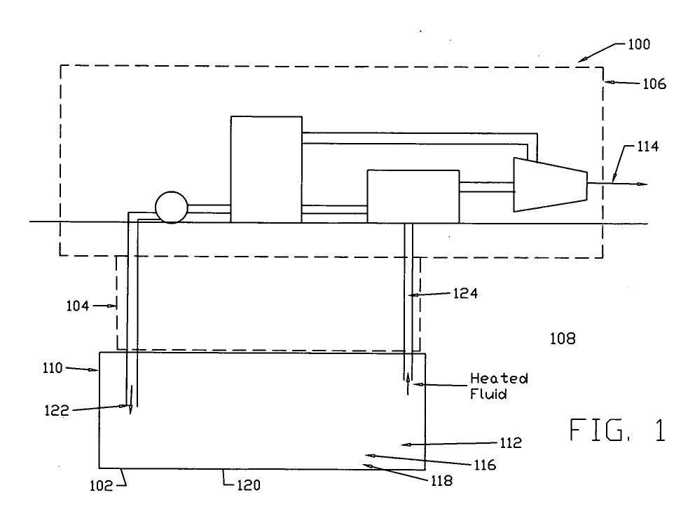

FIG. 1 illustrates a geothermal electrical generation system 100 in accordance with one embodiment of the present invention. The geothermal electrical generation system 100 includes a thermal chamber 102, a thermal conduit 104 and a power head 106. The thermal chamber 102 is disposed underground in a geothermal region 108 of the earth and is formed by chamber walls 110. A fluid 112 is circulated through the thermal chamber 102 and is heated by geothermal region 108. The heated fluid 112a is communicated to the power head 106 by thermal conduit 104. The power head 106 utilizes the heated fluid 112a to generate electricity 114 and cooled fluid 112b. The cooled fluid 112b is then communicated to the thermal chamber 102 through the thermal conduit 104. In the preferred embodiment, the fluid 112 circulates in a substantially closed loop through the thermal chamber 102, thermal conduit 104 and power head 106.

The fluid 112 may comprise any suitable fluid, in either a liquid or gaseous form, both, or cycled between a liquid and gaseous form through the geothermal electrical generation system 100. In the preferred embodiment, the fluid 112 comprises water. In this embodiment, the water is heated in the thermal chamber 102, which is then vaporized into steam that is used to power a turbine generator in the power head 106. The steam is then cooled and returned to a liquid form and pumped to the thermal chamber 102. Although the fluid 112 has been described in terms of its preferred embodiment, the fluid 112 may also comprise other suitable fluids, including brine, i.e., salt water, ammonia and nitrogen, without departing from the spirit and scope of the present invention.

The thermal chamber 102 may comprise any suitable chamber having a volume 116 sufficiently large that the fluid 112 in the thermal chamber 102 has a high residence time 118. An advantage is that the fluid 112 is heated to near equilibrium with the geothermal region 108. This maximizes the temperature of the fluid 112 leaving the thermal chamber 102 and further increases the efficiency of the geothermal electrical generation system 100.

The regions of the world can be categorized by the temperature profile of the geothermal regions 108. Geothermal systems are limited by the efficiency/cost of the particular design to certain temperature profiles. For example, most power generation geothermal systems are limited to regions having a temperature exceeding 150 degrees centigrade and having a down hole depth less than 2,000 feet. In some embodiments, the present invention allows commercial production of geothermal energy at temperatures less than 150 degrees centigrade and more than 2,000 feet.

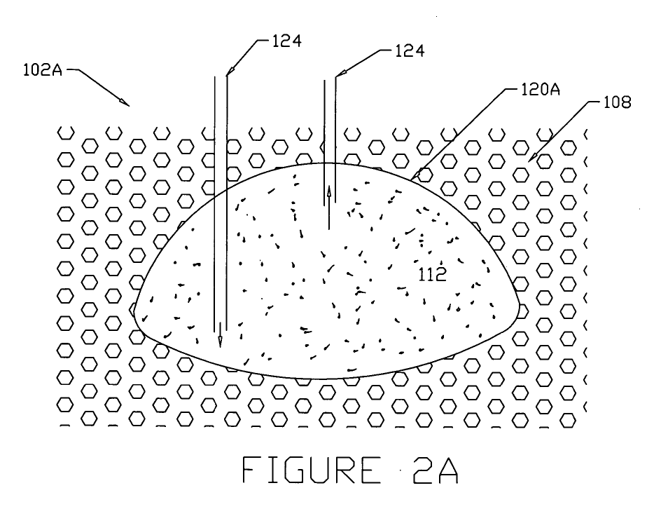

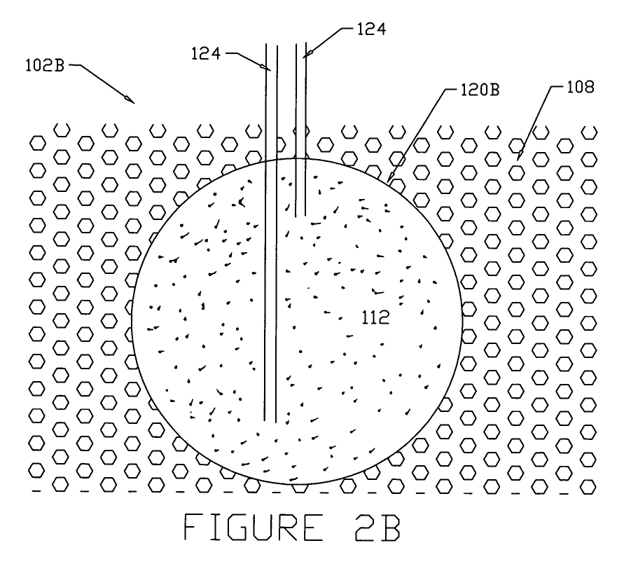

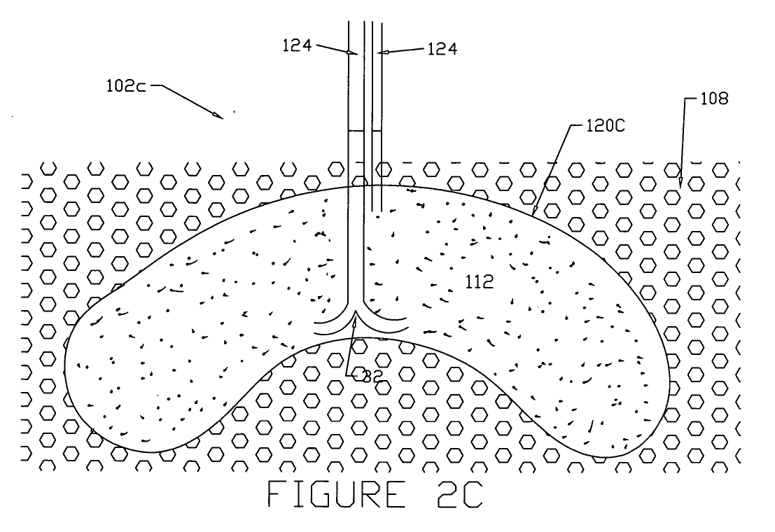

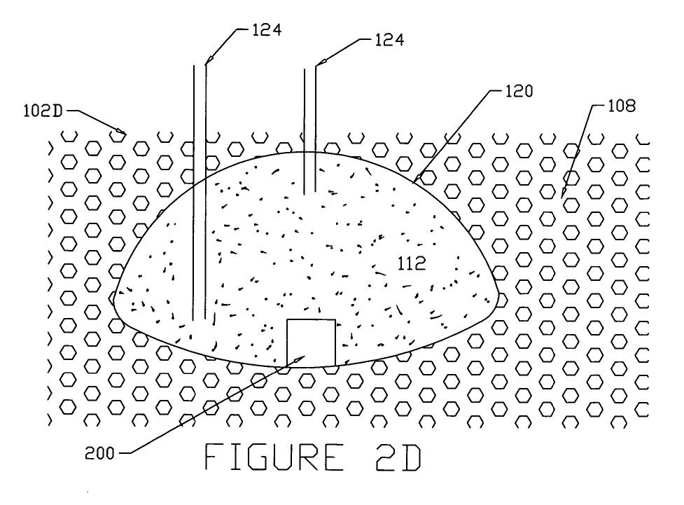

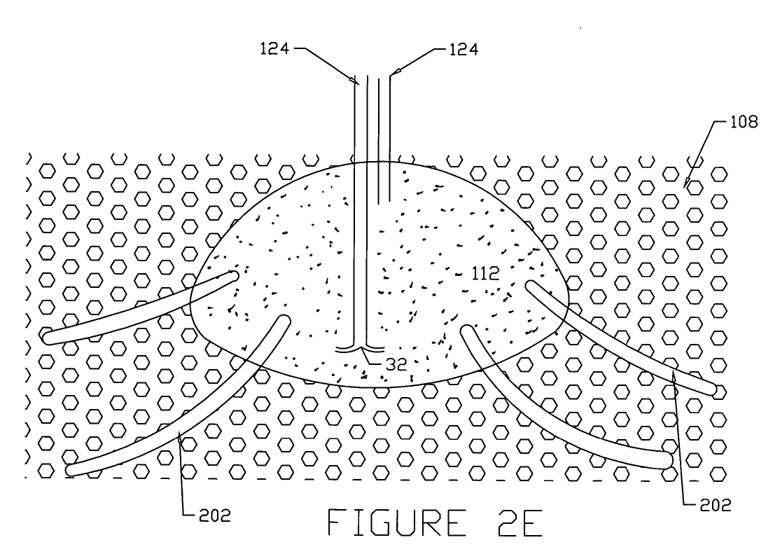

The thermal chamber 102 may comprise any suitable shape 30, some of which are illustrated in FIGS. 2A-2C. The shape 120 provides structural support and may also assist in circulating the fluid 112 within the thermal chamber 102. The thermal chamber 102 may be constructed using any suitable technique, including drilling, drift drilling, explosives, solution mining, spallation, laser drilling, under reaming, mining, remote mining, directional drilling, pressurized liquid and drilling wings. The preferred method of constructing the thermal chamber 102 will depend in part on the geological conditions and the economics for each construction technique.

The chamber walls 110 may be formed of bare rock from the geothermal region 108 or they can be lined with any suitable material to provide structural support, minimize contamination of the fluid 112 or prevent leakage of the fluid 112 into the geothermal region 118. For example, in some embodiments, the chamber walls 110 are formed using a binder material, such as cement or a plastic. In other embodiments, the chamber walls 110 are formed using a metallic shell.

In many locations, the geothermal region 118 is porous and may contain geothermal fluids, such a water, brine, or petroleum products. These geothermal fluids naturally occur and may circulate through the geothermal region 118. The circulation of the geothermal fluid can improve the transfer of heat to the thermal chamber 102 and minimize cold regions surrounding the thermal chamber 102. One problem is that the geothermal fluid can contaminate the fluid 112 if the chamber walls 110 are permeable. Accordingly, in the preferred embodiment, the chamber walls 110 are impermeable. In other embodiments, the chamber walls 110 are semi-permeable and any contamination from the geothermal fluid is limited or removed from the fluid 112.

The thermal chamber 102 may also include a mixer 122. The mixer 122 may comprise any suitable device or feature that facilitates the circulation of the fluid 112 within the thermal chamber 102. For example, the mixer 122 may comprise a directional nozzle, channels, the shape 120 or locating the fluid 112 input and output points so as to induce circulation.

FIGS. 2A-2E illustrate various embodiments of the thermal chamber 112. FIG. 2A illustrates a thermal chamber 112a having a domed shape 120a. FIG. 2b illustrates a thermal chamber 112b having a generally circular shape 120b. FIG. 2C illustrates a thermal chamber 102c having multi-cavern shape 120c. FIG. 2D illustrates a thermal chamber 102d having a heating element 200 that generates heat. In one embodiment, the heating element 200 comprises a low yield nuclear generator that generates heat through radioactive isotope decay. In this embodiment, the nuclear generator is preferably a self contained unit that does not require refueling, servicing and which cannot become critical. FIG. 2E illustrates a thermal chamber 102e that includes at least one heat conductor 202 that operates to communicate thermal energy from the geothermal region 108 to the fluid 112. In the preferred embodiment, the heat conductor 202 comprises a thermally conductive rod that extends beyond the chamber walls 110.

Although the thermal chamber 102 has been described in terms of specific features and functionality, the thermal chamber 102 may comprise other suitable features without and without departing from the scope of the invention. For example, the thermal chamber 102 may comprise other suitable shapes 120 or choke points for vaporizing the heated fluid 112 prior to communicating the heated fluid 112 through the thermal conduit 104 to the power head 106.

Referring to FIG. 1, the thermal conduit 104 may comprise any suitable device or system for communicating the fluid 112 between the thermal chamber 102 and the power head 106. The thermal conduit 104 comprises at least one borehole 124. In the preferred embodiment, the thermal conduit 104 comprises a first borehole 124a and a second borehole 124b. In this embodiment, the first borehole 124a includes at least one pipe that operates to communicate the fluid 112 down from the power head 106 to the thermal chamber 102 and the second borehole 124b having at least one pipe that operates to communicate the heated fluid 112 from the thermal chamber 102 to the power head 16. In another embodiment, the thermal conduit comprises a single borehole 124. In this embodiment, the pipes used to circulate the fluid 112 between the thermal chamber 102 and the power head 106 are contained within the single borehole 124.

The thermal conduit 104 may also comprise other suitable features and devices without departing from the scope of the invention. For example, the pipes in the borehole 124 are preferably insulated in order to maximize the temperature of the fluid 112, and the thermal conduit 104 may include pumps, sensors and other monitoring equipment.

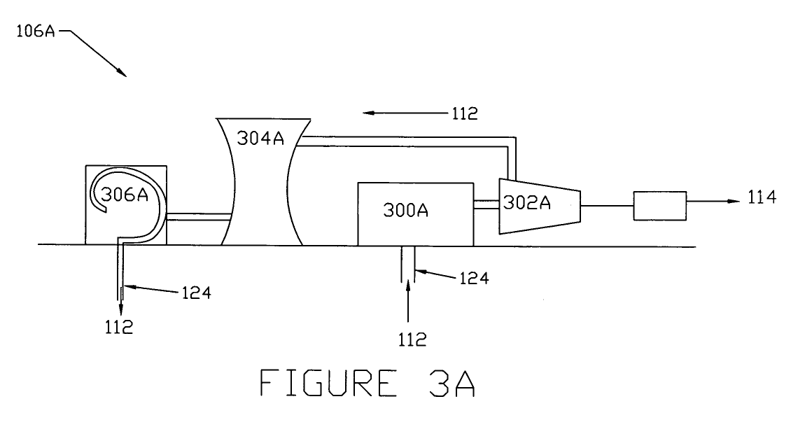

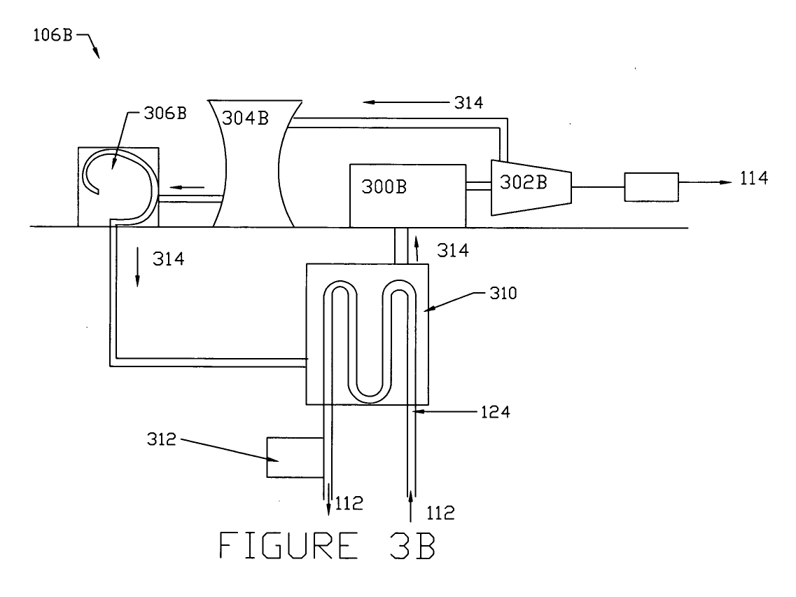

Referring to FIG. 1, the power head 106 may comprise any suitable system for converting thermal energy from the fluid 112 into electricity 114, some of which are illustrated in FIGS. 3A-3B. FIG. 3A illustrates an example of a single stage power head 106a. In this embodiment, the power head 106a comprises a vaporization system 300a, a turbine generator 302a, a liquefaction system 304a and a pumping system 306a. The vaporization system 300a operates to convert the heated fluid 112 from a liquid form into gaseous form. The turbine generator 302a receives the gaseous fluid 112 from the vaporization system and utilizes the pressurized fluid 112 to power a turbine, which in turn powers a generator that creates electricity 114. The pressure and temperature of the gaseous fluid 112 decreases as it flows through the turbine generator 302a. In the preferred embodiment, the turbine generator 302a has a multistage turbine to maximize the energy removed from the gaseous fluid 112. The liquefaction system 304a operates to convert the low pressure/temperature gaseous fluid 22 into a liquid form. In the preferred embodiment, the liquefaction system 304a includes a cooling system that cools the gaseous fluid 112 so that it condenses back into liquid form. The pumping system 306a operates to pump the fluid 112 from the liquefaction system 304a through the conduit system 104 to the thermal chamber 102. In some embodiments, the pumping system 306a also provides the pumping power, i.e., pressure, to circulate the fluid 112 through entire system.

FIG. 3B illustrates an example of a dual stage power head 106b. In this embodiment, the power head 106b includes a heat exchanger 310 and a fluid pumping system 312. The heat exchanger 310 operates to exchange heat between the heated fluid 112 and a working fluid 314. The fluid pumping system 312 operates to circulate the fluid 112 between the thermal chamber 102 and the heat exchanger 310. The power head 106b generally includes a vaporization system 300b, a turbine generator 302b, a liquefaction system 304b and a pumping system 306b. The power head 106b operates in a manner similar to the power head 106a except that the pumping system 306b operates to pump the working fluid 314 through the heat exchanger 310.

In general, the fluid 112 is different than the working fluid 312. The advantage of using a dual stage power head 106b is that the fluid 112 circulated through the thermal chamber 112 may comprise a fluid that is unsuitable or inefficient for the generating power in the power head 106. For example, if the fluid 112 comprises brine, the salts in the water will damage, i.e., rust, scale, corrode, and contaminate, the components of the power head 106. The working fluid 312 can also be chosen to maximize the efficiency of the turbine generator 302b or use a working fluid 312 that cannot be safely used in a down hole environment. For example, the working fluid 312 may comprise an ammonia, isopentane and/or osobutane based fluid, which in some power generation systems is more efficient in low temperature applications. The disadvantage of the dual stage power head 106b is that it is generally less efficient than a singe stage power head 106.

Although the power head 106 has been described in terms of specific components, features and functionality, the power head 106 may comprise other components, features and functionality without departing from the scope of the invention. For example, the power head 106 may include holding stations, fluid reservoirs, filters, and other such components and features that are typical in power generation facilities.

I claim:

1. A geothermal electrical generation system comprising:
a thermal chamber disposed in an underground geothermal region, wherein the thermal chamber contains a fluid heated by the geothermal region;
a power head operable to generate electricity from the heated fluid; and
a thermal conduit operable to communicate the heated fluid from the thermal chamber to the power head.

2. The geothermal electrical generation system of claim 1, wherein the thermal chamber includes a wall that is impermeable.

3. The geothermal electrical generation system of claim 1, wherein the thermal chamber includes a wall that is semi-permeable.

4. The geothermal electrical generation system of claim 1, wherein the thermal chamber has a volume greater than 2,000 cubic meters.

5. The geothermal electrical generation system of claim 1, wherein the thermal chamber is generally domed.

6. The geothermal electrical generation system of claim 1, wherein the fluid is circulated in a closed loop.

7. The geothermal electrical system of claim 1, wherein the fluid is directionally circulated within the thermal chamber.

8. The geothermal electrical generation system of claim 1, wherein the power head includes a heat exchanger having a working fluid heated by the heated fluid.

9. A method for generating electricity comprising:
circulating a fluid having an energy state through a thermal chamber and a power head, wherein:
the fluid entering the thermal chamber is at a first energy state;
the energy state of the fluid is increased from the first energy state to a second energy state by heating the fluid from a thermal region disposed outwardly from the thermal chamber; and
the fluid at the second energy state from the thermal chamber is delivered to the power head where at least part of portion the difference in energy states between the first energy state and the second energy is converted into mechanical energy; and
converting at least a portion of the mechanical energy into electricity.

10. The method for generating electricity of claim 9, wherein the fluid is circulated in a closed loop through the thermal chamber and the power head.

11. The method for generating electricity of claim 9, wherein the fluid is directionally circulated within the thermal chamber.

12. The method for generating electricity of claim 9, wherein circulating the fluid through the power head and converting the difference in energy states into mechanical energy comprises:
circulating the fluid at the second energy state through a heat exchanger to heat a working fluid from a first energy state to a second energy state;
converting at least a portion of the difference between the second energy state and the first energy state of the working fluid into mechanical energy.

13. The method for generating electricity of claim 12, wherein converting at least a portion of the difference between energy states comprises:
vaporizing the working fluid at the second energy state into a gaseous working fluid;
converting at least a portion of the energy in the gaseous working fluid into mechanical energy; and
liquefying the gaseous working fluid.

14. The method for generating electricity of claim 9, wherein the thermal chamber is semi-permeable.

15. The method for generating electricity of claim 9, wherein the thermal chamber has a volume of at least 60 cubic feet.

16. A geothermal electrical generation system for generating electricity comprising:
a thermal chamber disposed in a thermal region of the earth, with chamber walls that are generally impermeable, and having a volume exceeding 5,000 cubic meters;
a power head comprising a vaporization system, a generator system, a liquefaction system and a pumping system; and
a thermal conduit through which a fluid is communicated through the thermal chamber and the power head.

17. The geothermal electrical generation system of claim 16, wherein the thermal chamber is located more than 2,000 feet underground.

18. The geothermal electrical generation system of claim 16, wherein thermal conduit comprises a plurality of bore holes.

19. The geothermal electrical generation system of claim 16, wherein the power head comprises a two stage power head.

20. The method for generating electricity of claim 16, wherein the fluid is directionally circulated within the thermal chamber.
